(19) United States
(12) Patent Application Publication
(10) Pub. No.: US 2015/0023757 A1
(43) Pub. Date: Jan. 22, 2015

(54) HOUSING WITH NUT AND METHOD FOR FIXING THE NUT IN THE HOUSING

(71) Applicant: FIH (HONG KONG) LIMITED, Kowloon (HK)

(72) Inventors: CHIH-WEI CHANG, New Taipei (TW); SHIH-WEI YANG, Shindian (TW)

(73) Assignee: FIH (HONG KONG) LIMITED, Kowloon (HK)

(21) Appl. No.: 14/069,608

(22) Filed: Nov. 1, 2013

(30) Foreign Application Priority Data
Jul. 19, 2013 (CN) 201310304853X

(51) Int. Cl. F16B 41/00

(52) U.S. Cl. CPC F16B 41/002
USPC 411/173; 29/525.12

(57) ABSTRACT

A method for fixing at least one nut in a housing is provided. The nut includes a latching portion, and the housing defines a connecting hole. The method includes providing a pressing block, placing the nut into the connecting hole of the housing, engaging the pressing block with the nut, heating the pressing block and transmitting heat energy to the nut, rotating the nut into the connecting hole, and melting a portion of an inner wall of the connecting hole to solidify molten material in the latching portion, thereby fixing the nut in the housing.

### BACKGROUND

1. Technical Field

The present disclosure relates to a housing with a nut and a method for fixing the nut in the housing.

2. Description of related art

Housings of portable electronic devices often include an upper housing and a lower housing. The upper housing is often fixed to the lower housing by nuts and bolts. During manufacturing, the nuts are just perpendicularly pressed into either the upper housing or the lower housing. However, this method cannot stably secure the nuts to the corresponding housing.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles. Moreover, in the drawings like reference numerals designate corresponding parts throughout the several views.

FIG. 1 shows a schematic view of a first exemplary embodiment of a nut configured for being embedded in a housing by a pressing block.

FIG. 2 shows a partial view of the housing.

FIG. 3 shows the pressing block and the nut aligned with a connecting hole of the housing.

FIG. 4 shows a schematic view of a second exemplary embodiment of the nut and the pressing block for the housing.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

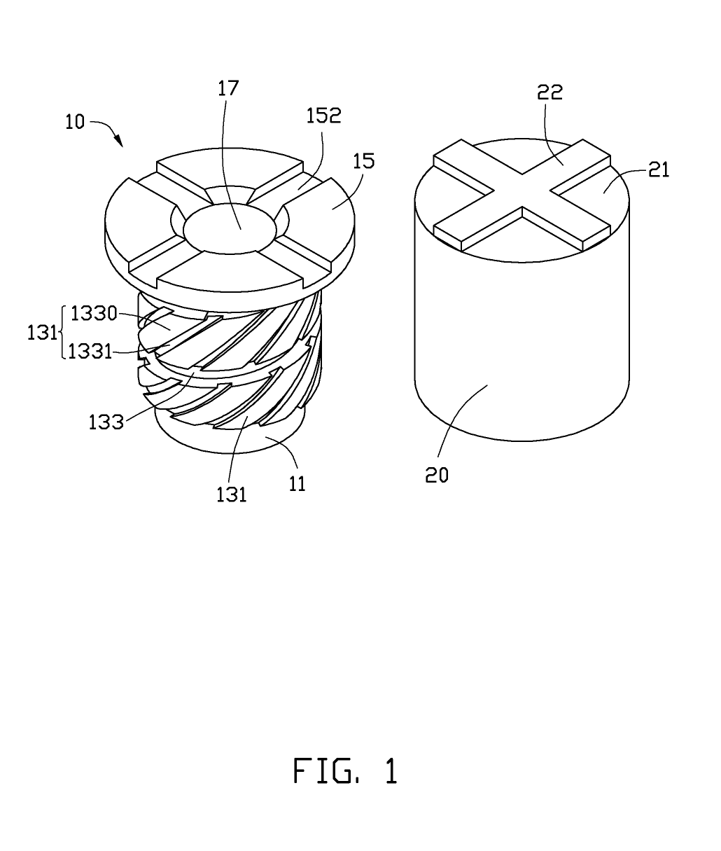

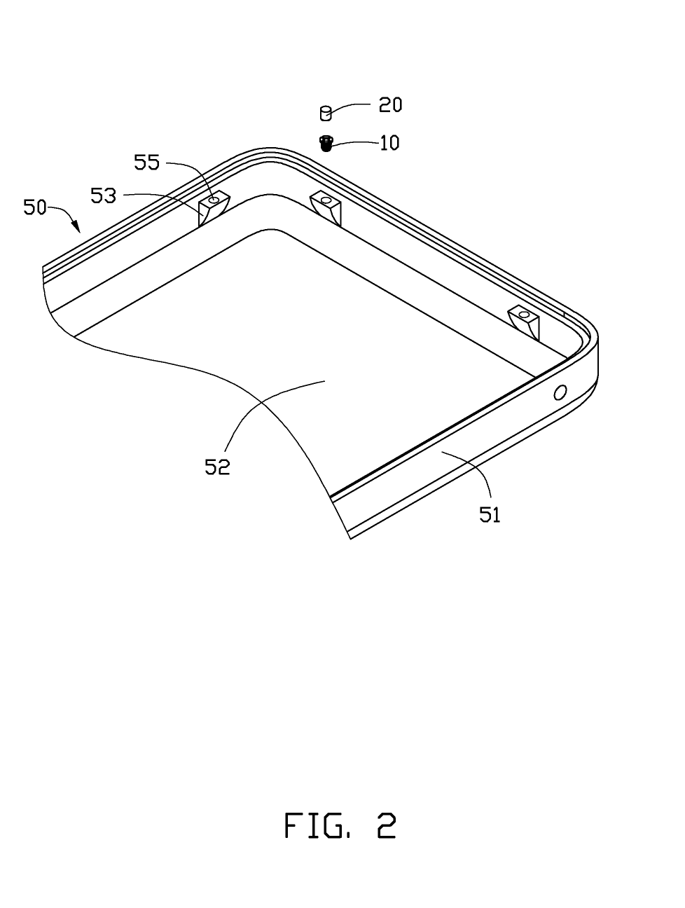

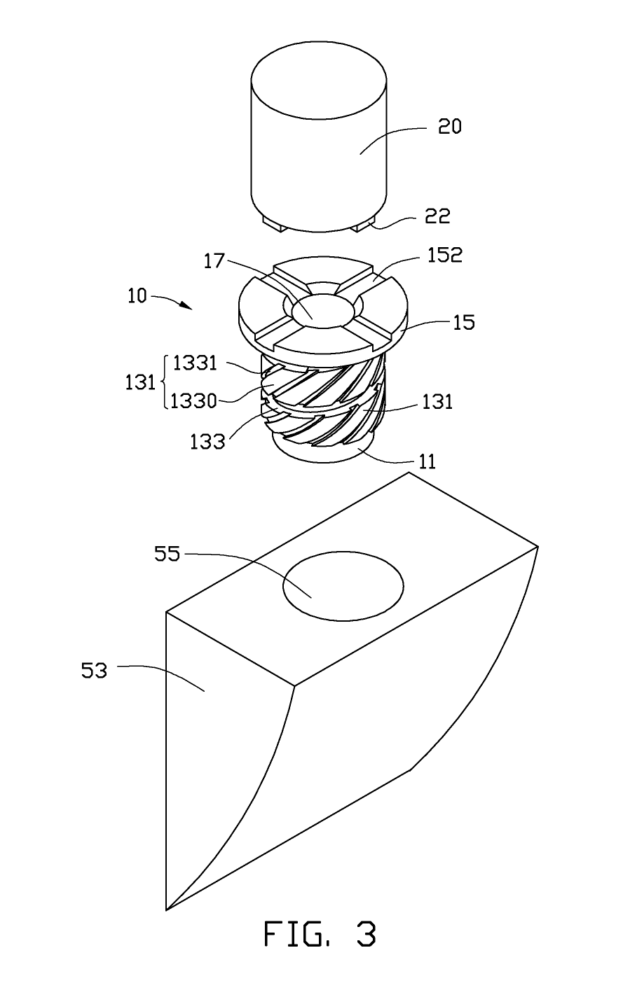

FIGS. 1-3 illustrate a method for using a pressing block 20 for fixing at least one nut 10 in a housing 50 to form a connecting structure.

The nut 10 is made of metal and includes a nut body 11 and a head portion 15. The nut body 11 is substantially cylindrical, and at least one latching portion 131 is formed along an outer peripheral surface of the nut body 11. In one embodiment, two latching portions 131 are arranged along the outer peripheral surface of the nut body 11 and are spaced from each other. Each latching portion 131 is made of a plurality of helical ridges 1330 and a plurality of helical grooves 1331 defined between adjacent helical ridges 1330. A tilted angle of the helical grooves 1331 of the two latching portions 131 is substantially the same. An annular groove 133 is defined between the two latching portions 131. The head portion 15 is substantially a disk-shaped plate and is located at one end of the nut body 11. One surface of the head portion 15 defines a positioning groove 152. In this exemplary embodiment, the positioning groove 152 is cross-shaped. A through hole 17 is defined in the head portion 15 and the nut body 11.

The pressing block 20 is configured for connecting to a heat pressing machine (not shown). The heat pressing machine transmits heat energy to the pressing block 20. The pressing block 20 rotates the nut 10. In this exemplary embodiment, the pressing block 20 is cylindrical and has an end surface 21. A positioning projection 22 is formed on the end surface 21 to be received in the positioning groove 152. In this exemplary embodiment, the positioning projection 22 is cross-shaped. In another embodiment, a size and shape of the pressing block 20 is varied according to a size and shape of the head portion 15.

In one embodiment, the housing 50 is formed by injection molding a moldable material. The moldable material can be made of a resin selected from a group consisting of polypropylene (PP), polyamide (PA), polycarbonate (PC), polyethylene terephthalate

(PET), and polymethylmethacrylate (PMMA), for example. The housing 50 includes a base plate 52 and at least one sidewall 51 extending from the base plate 52. At least one support block 53 is formed on an inner surface of the sidewall 51. A connecting hole 55 is defined in the support block 53 interlocking with the nut 10.

An exemplary embodiment of a method for mounting the nut 10 to the housing 50 may include the following steps:

The nut 10 is firstly loosely received in the connecting hole 55. The pressing block 20 connected to the heat pressing machine is aligned with the nut 10, and the positioning projection 22 is received in the positioning groove 152 to allow the pressing block 20 to rotate the nut 10. After that, the pressing block 20 is heated by the heat pressing machine to transmit heat energy to the nut 10. Next, the pressing block 20, driven by the heat pressing machine, rotates the nut 10 into the connecting hole 55. When the nut 10 rotates into the connecting hole 55, the latching portions 131 are rotated into the connecting hole 55. The heated nut 10 melts portions of an inner wall of the connecting hole 55 to form molten material. The molten material enters into the annular groove 133. The pressing block 20 and the nut 10 keep rotating until the head portion 15 abuts and resists the support block 53. The pressing block 20 is removed from the nut 10, and the molten material cools and solidifies in the annular groove 133, thereby fixing the latching portions 131 in the support block 53. The molten material also solidifies in the helical grooves 1331, thereby improving a bonding strength between the housing 50 and the nut 10 as a result of the increased contact area. Thus, the nut 10 is secured to the housing 50, and a structural strength of the connecting structure is improved. A bolt of an accessory member (not shown) may be fixedly received in the through hole 17 of the nut 10 to fix the accessory member to the housing 50.

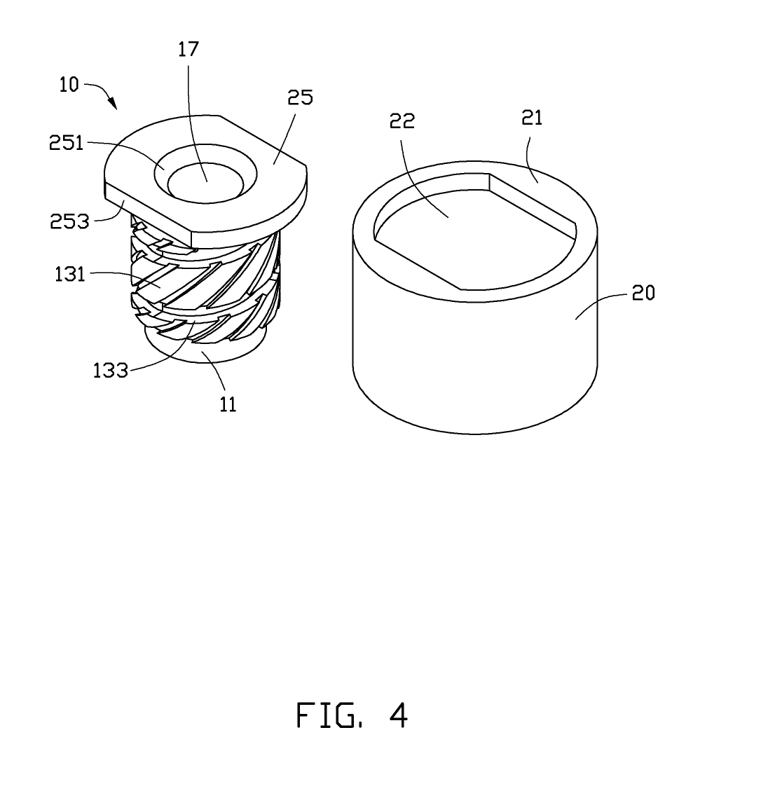

FIG. 4 illustrates a second exemplary embodiment. The nut 10 has a head portion 25. The head portion 25 includes two opposite arcuate surfaces formed between two opposite planar surfaces 253. One surface of the head portion 25 defines a conical groove 251 communicating with the through hole 17. One end 21 of the pressing block 20 defines a receiving groove 22 corresponding to the head portion 25. The head portion 25 is received by the receiving groove 22 to allow the pressing block 20 to rotate the nut 10.

It should be also understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method of fixing a nut into a housing, the nut including a latching portion, the housing defining a connecting hole, comprising:
providing a pressing block;
placing the nut into the connecting hole of the housing;
engaging the pressing block with the nut;
heating the pressing block and transmitting heat energy to the nut;
rotating and moving the pressing block and the nut together into the connecting hole; and
melting a portion of an inner wall of the connecting hole by the nut to embed molten material into the latching portion for bonding the nut to the housing.

2. The method according to claim 1, wherein the pressing block is cylindrical, and has a positioning projection formed at on end, the nut includes a head portion, the head portion defines a positioning groove interlocking with the positioning projection.

3. The method according to claim 1, wherein the housing is made of a material chosen from the group consisting of polypropylene, polyamide, polycarbonate, polyethylene terephthalate, and polymethylmethacrylate.

4. A connecting structure comprising:
a housing defining a connecting hole; and
a nut including a nut body and at least one latching portion formed on the nut body;
wherein the nut body is received in the connecting hole and the at least one latching portion is embedded into the housing.

5. The connecting structure as claimed in claim 4, wherein there are two latching portions are arranged on the nut body along the same direction, and are spaced from each other, a annular groove is defined between the two latching portions.

6. The connecting structure as claimed in claim 5, wherein the nut further comprises a head portion positioned at one end of the nut body, the pressing block has a positioning projection formed at on end, the head portion defines a positioning groove interlocking with the positioning projection.

7. The connecting structure as claimed in claim 6, wherein the positioning groove is cross-shaped, and the positioning projection is cross-shaped.

8. The connecting structure as claimed in claim 4, wherein the housing includes a base plate and at least one sidewall extending from the base plate, at least one support block is formed in an inner surface of the sidewall, the connecting hole is defined in the support block.
